(19) United States
(12) Patent Application Publication
(10) Pub. No.: US 2019/0130474 A1
(43) Pub. Date: May 2, 2019

(54) ORDER PARAMETER GENERATION SUPPORTING DEVICE AND ORDER PARAMETER GENERATING METHOD

(71) Applicant: HITACHI, LTD., Tokyo (JP)

(72) Inventor: Akihisa TSUJIBE, Tokyo (JP)

(21) Appl. No.: 16/093,670

(22) PCT Filed: Sep. 27, 2016
(86) PCT No.: PCT/JP2016/078425

§ 371 Date: Oct. 15, 2018

(51) Int. Cl. G06Q 30/06; G06Q 10/08

(52) U.S. Cl. CPC G06Q 30/0637; G06Q 10/087

(57) ABSTRACT

An order parameter generation supporting device includes: a storage unit which stores a consumption amount assumption scenario including an assumed consumption amount, consumption plan information including a consumption amount in a consumption plan, and master information including, as an order parameter which is a value related to an order, the order parameter at a current time; an order parameter changing combination creation unit which creates a combination of order parameters including an order parameter candidate which is to be a change candidate of the order parameter; a stock evaluation unit which determines whether or not one or a plurality of combinations of the order parameters is appropriate for each of the consumption amount in the consumption plan and the assumed consumption amount; and an order parameter changing plan output unit which generates display information of an evaluation result screen including the combination of order parameters on which determination is performed.

### TECHNICAL FIELD

The present invention relates to an order parameter generation supporting device and an order parameter generating method.

### BACKGROUND ART

PTL 1 discloses a technology relating to a production plan change decision supporting device. In Paragraph [0020] of the afore-mentioned document, it is disclosed that “in this system, particularly, the PSI information of products/parts at each decision point which is to be changed from the current production plan to a new production plan is calculated and stored (105 in FIG. 1, S009 in FIG. 3), the management risk is calculated at each decision point (106, S010), and the point at which the plan change is recommended is determined on the basis of the change in the management risk (107, S011)”. In addition, as a result of the process, in the same paragraph, it is disclosed that “the screen for guiding/supporting the decision and the like by the user, that includes the above information, is generated and displayed”.

### CITATION LIST

### Patent Literature

PTL 1: JP-A-2015-14826

### SUMMARY OF INVENTION

### Technical Problem

In a manufacturing industry, an ordering entity of apart contracts with suppliers on the basis of various order parameters such as a purchase unit and a procurement lead time. Since the determination as to whether or not these order parameters are appropriate depends on a person in charge, there is a concern that problems such as excessive stock may occur depending on the person in charge. In addition, there is a possibility that the consumption amount that will occur in the future may fluctuate, but it is necessary to generate an appropriate order parameter in consideration of fluctuation in the consumption amount.

The technology described in PTL 1 performs a recommended decision point determination process for each demand scenario which is future demand information, but the technology does not support the generation of an appropriate order parameter.

In view of the above-described points, an object of the present invention is to provide a technology for supporting generation of more appropriate order parameter.

### Solution to Problem

The present application includes a plurality of means for solving at least a portion of the above-mentioned problems. For example, the means are as follows.

In order to solve the above problems, according to one aspect of the present invention, there is provided an order parameter generation supporting device including: a storage unit which stores a consumption amount assumption scenario including an assumed consumption amount, consumption plan information including a consumption amount in a consumption plan, and master information including, as an order parameter which is a value related to an order, the order parameter at a current time; an order parameter changing combination creation unit which creates a combination of order parameters including an order parameter candidate which is to be a change candidate of the order parameter; an stock evaluation unit which determines whether or not one or a plurality of combinations of the order parameters is appropriate for each of the consumption amount in the consumption plan and the assumed consumption amount; and an order parameter changing plan output unit which generates display information of an evaluation result screen including the combination of order parameters on which determination is performed by the stock evaluation unit.

In addition, in order to solve the above problems, according to another aspect of the present invention, there is provided an order parameter generating method performed by an order parameter generation supporting device, wherein the order parameter generation supporting device includes a storage unit, an order parameter changing combination creation unit, a stock evaluation unit, and an order parameter changing plan output unit, wherein the storage unit stores a consumption amount assumption scenario including an assumed consumption amount, consumption plan information including a consumption amount in a consumption plan, and master information including, as an order parameter which is a value related to an order, the order parameter at a current time, wherein the order parameter changing combination creation unit executes an order parameter change combination creation procedure of creating a combination of order parameters including an order parameter candidate which is to be a change candidate of the order parameter, wherein the stock evaluation unit executes a stock evaluation procedure of calculating, for each of the combinations of order parameters, a stock amount at a predetermined reference time for each of the assumed consumption amount and the consumption amount in the consumption plan and determining whether or not each of the combination of order parameters is appropriate, and wherein the order parameter changing plan output unit executes an order parameter changing plan output procedure for displaying an evaluation result screen including the combination of order parameters on which the determination is performed by the stock evaluation unit.

### Advantageous Effects of Invention

According to the present invention, it is possible to provide a technology for supporting generation of more appropriate order parameters.

The problems, configurations, and effects other than those described above will be clarified by the description of the following embodiments.

### BRIEF DESCRIPTION OF DRAWINGS

FIG. 1 is a diagram illustrating an example of functional blocks of an order parameter generation support system.

FIG. 2 is a diagram illustrating an example of a data structure of stock information.

FIG. 3 is a diagram illustrating an example of a data structure of consumption plan information.

FIG. 4 is a diagram illustrating an example of a data structure of warehousing plan information.

FIG. 5 is a diagram illustrating an example of a data structure of master information.

FIG. 6 is a diagram illustrating an example of a data structure of part configuration information.

FIG. 7 is a diagram illustrating an example of a data structure of evaluation object information.

FIG. 8 is a diagram illustrating an example of a data structure of assumed scenario information.

FIG. 9 is a diagram illustrating an example of a data structure of order parameter changing plan information.

FIG. 10 is a diagram illustrating an example of a data structure of evaluation result information.

FIG. 11 is a diagram illustrating a hardware configuration example of an order parameter generation supporting device.

FIG. 12 is a flowchart illustrating an example of an order parameter generation supporting process.

FIG. 13 is a diagram illustrating an example of a stock trend simulation process.

FIG. 14 is a diagram illustrating an example of a stock trend simulation process in a case where an out-of-stock item occurs.

FIG. 15 is a view illustrating an example of an evaluation result screen.

FIG. 16 is a flowchart illustrating an example of an order parameter generation supporting process in Modified Example 1.

FIG. 17 is a view illustrating an example of an evaluation result screen in Modified Example 2.

### DESCRIPTION OF EMBODIMENTS

Hereinafter, examples of embodiments of the present invention will be described with reference to the drawings. An order parameter generation support system 1 according to the present embodiment supports generation of order parameters used by, for example, an ordering entity operating in a manufacturing industry to purchase object products from a supplier. The object products include, for example, an electrical product, a mechanical product, a transport device such as a car, an electric train, an aircraft, a conveyor, and an escalator, a generator, a control device, a control panel, a storage device, a network storage such as a network attached storage (NAS), a server device, a water treatment device, and the like, and parts thereof. Hereinafter, the embodiment will be described by using an example in which the object products are parts and a product is constituted by the parts. In addition, the parts may be products themselves.

The order parameter is a value relating to ordering and, for example, is used for contracting with a supplier. The order parameters include a purchase unit which is a unit amount of the parts purchased from the supplier, a procurement lead time which is a period from the time when the parts are ordered to the supplier to the time when the parts are delivered, or a safe stock amount which is a reserve stock of the ordering entity. The safe stock amount is a standard value of the stock amount that is considered not to be likely to be out of stock until the stock amount falls below this safe stock amount. The safe stock amount can be changed as needed similarly to other order parameters.

If a contract is concluded with a supplier and an order parameter is determined, in many cases, it may not be verified whether or not the order parameter is valid. Therefore, in the case of changing the determined order parameter, it is difficult to determine whether or not the order parameter is appropriate as a newly generated changing plan.

According to the order parameter generation support system 1 in the present embodiment, it is possible to generate a changing plan of the order parameter and determine the validity. In addition, by displaying the determination result, it is possible to support generation of an appropriate order parameter.

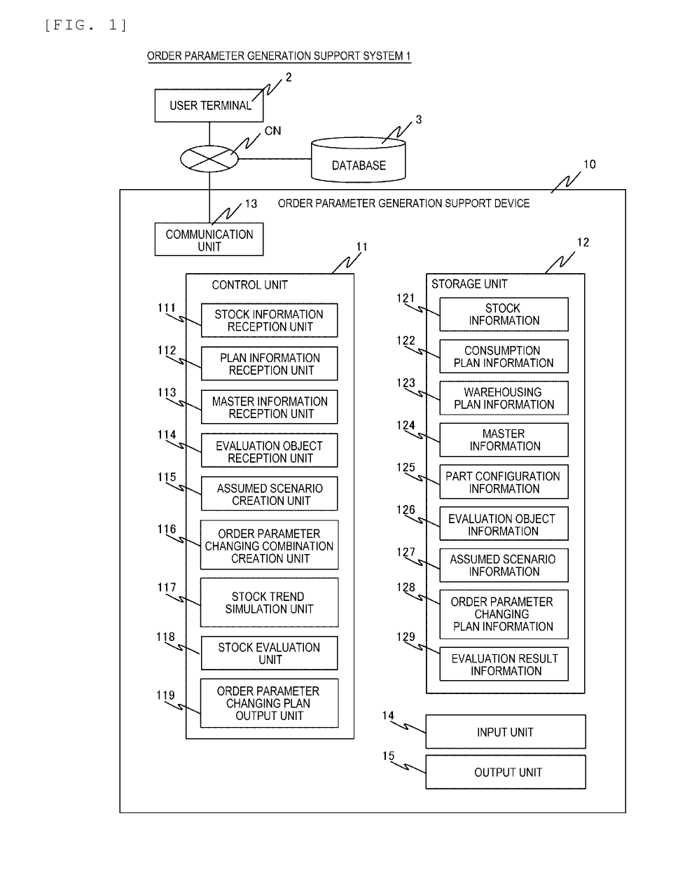

FIG. 1 is a diagram illustrating an example of functional blocks of the order parameter generation support system 1. The order parameter generation support system 1 is configured to include a user terminal 2, a database 3, and an order parameter generation supporting device 10, each of which is communicably connected via a network CN.

The user terminal 2 is an information processing device such as a PC (Personal Computer) and is operated by a user of an order parameter generation service provided by the order parameter generation supporting device 10. The database 3 is, for example, a system such as ERP (Enterprise Resource Planning), or a database or a storage device which stores data conforming thereto.

The network CN communicably connects the user terminal 2, the database 3, and the order parameter generation supporting device 10. The network CN is one of communication networks using a portion or all of, for example, a LAN (Local Area Network), a WAN (Wide Area Network), a VPN (Virtual Private Network), and a general public line such as the Internet.

The order parameter generation supporting device 10 is an information processing device such as a PC or a server computer. The order parameter generation supporting device 10 is configured to include a control unit 11, a storage unit 12, a communication unit 13, an input unit 14, and an output unit 15.

The control unit 11 overall controls the entire order parameter generation supporting device 10. The storage unit 12 stores information necessary for supporting the generation of order parameters. The communication unit 13 transmits or receives information to or from other devices connected via the network CN. The input unit 14 receives an input of information to the order parameter generation supporting device 10 through an input device such as a keyboard or a touch panel. The output unit 15 outputs information to an output device such as a display.

The control unit 11 is configured to include a stock information reception unit 111, a plan information reception unit 112, a master information reception unit 113, an evaluation object reception unit 114, an assumed scenario creation unit 115, an order parameter changing combination creation unit 116, a stock trend simulation unit 117, a stock evaluation unit 118, and an order parameter changing plan output unit 119.

The stock information reception unit 111, the plan information reception unit 112, the master information reception unit 113, and the evaluation object reception unit 114 respectively acquire necessary information from the user terminal 2 or the database 3 through the communication unit 13. In addition, the stock information reception unit 111, the plan information reception unit 112, the master information reception unit 113, and the evaluation object reception unit 114 may receive necessary information through the input unit 14.

More specifically, the stock information reception unit 111 receives stock information and stores the stock information in the storage unit 12. The plan information reception unit 112 receives consumption plan information and warehousing plan information and stores the consumption plan information and the warehousing plan information in the storage unit 12. The master information reception unit 113 receives master information and part configuration information and stores the master information and the part configuration information in the storage unit 12. The evaluation object reception unit 114 receives evaluation object information and stores the evaluation object information in the storage unit 12.

The assumed scenario creation unit 115 creates assumed scenario information including a consumption amount that is assumed in the future. The assumed scenario creation unit 115 estimates a consumption fluctuation tendency by using past consumption plan information and creates the assumed scenario information by using the consumption fluctuation tendency. The assumed scenario creation unit 115 estimates the consumption fluctuation tendency by using a general method.

In addition, the assumed scenario creation unit 115 may create the assumed scenario information in a case where consumption is simply increased, or may create the assumed scenario information in a case where consumption is simply decreased. In addition, the assumed scenario creation unit 115 may create the assumed scenario information by receiving the input of the consumption amount through the input unit 14. The assumed scenario creation unit 115 stores the created assumed scenario information in the storage unit 12.

In addition, in a case where the consumption amount of a certain part is adjusted, the assumed scenario creation unit 115 generates an assumed scenario by using the adjusted consumption amount for other parts which together with the adjusted parts constitutes a common product. The details will be described later.

The order parameter changing combination creation unit 116 creates a plurality of combinations of order parameters. At least one of the created combinations of the order parameters includes an order parameter candidate which is to be a change candidate of the order parameter. The order parameter changing combination creation unit 116 receives an input of information specifying the range of the value of the order parameter candidate, extracts the order parameter candidate, and combines the order parameter candidate with other order parameter to create the order parameter changing plan information. The order parameter changing combination creation unit 116 stores the created order parameter changing plan information in the storage unit 12.

The stock trend simulation unit 117 simulates the stock trend of the parts by using the stock information, the consumption plan information or the assumed scenario information, the warehousing plan information, and the master information. The stock trend simulation unit 117 creates stock trend simulation information by using the simulation result. In addition, in a case where the predetermined condition is satisfied, the stock trend simulation unit 117 adjusts the consumption amount in the consumption plan, which will be described in detail later.

The stock evaluation unit 118 determines whether or not the combination of order parameters is appropriate for each of the consumption amount in the consumption plan and the assumed consumption amount. The stock evaluation unit 118 calculates a stock amount in a case where the consumption amount in the consumption plan is used and a stock amount in a case where the assumed consumption amount is used for every combination of the order parameters.

In a case where the stock amount satisfies a predetermined condition, the stock evaluation unit 118 determines that the combination of order parameters for the consumption amount in the consumption plan or the assumed consumption amount is appropriate. For example, in a case where the calculated stock amount is 0 or more and the stock target value or less that is predetermined for each part in advance, the stock evaluation unit 118 determines that the order parameter is appropriate.

In addition, the stock evaluation unit 118 calculates the stock amount using the consumption amount in the consumption plan as the planned stock amount at the current time by using the order parameter at the start of the process. The stock evaluation unit 118 creates evaluation result information including the evaluation result and stores the evaluation result information in the storage unit 12.

The order parameter changing plan output unit 119 generates display information of the evaluation result screen displaying the combination of order parameters determined to be appropriate and transmits the display information to the user terminal 2 through the communication unit 13. The evaluation result screen is displayed on the user terminal 2. In addition, the evaluation result screen may be displayed on the output device of the order parameter generation supporting device 10 through the output unit 15. On the evaluation result screen, for each of the combination of order parameters at the current time and the combination of order parameters as the changing plan, a graph illustrating the stock trend of parts is displayed.

The storage unit 12 stores stock information 121, consumption plan information 122, warehousing plan information 123, master information 124, part configuration information 125, evaluation object information 126, assumed scenario information 127, order parameter changing plan information 128, and evaluation result information 129.

The stock information 121 is information on a stock amount owned by the ordering entity. The consumption plan information 122 is information on a future consumption plan and includes a consumption amount in the consumption plan. The warehousing plan information 123 is information on parts to be warehoused in the ordering entity. The master information 124 is information including an order parameter. The order parameter included in the master information 124 is set under the agreement with the supplier at the start of processing.

The part configuration information 125 is information on parts handled by the ordering entity and products constituted by the parts. The evaluation object information 126 is information on an evaluation reference for a part which is an evaluation object. It can be said that the evaluation object information 126 includes a condition for determining whether or not the combination of order parameters is appropriate.

The assumed scenario information 127 is information on a consumption amount assumed in the future. The order parameter changing plan information 128 is information including a plurality of combinations of order parameters. The evaluation result information 129 is information including the evaluation result determined for each of the combinations of order parameters.

In addition, in the present embodiment, the user terminal 2 and the database 3 are provided outside the order parameter generation supporting device 10, but the configuration of the order parameter generation support system 1 is not limited thereto. For example, the information stored in the storage unit 12 may be stored in the database 3, and the control unit 11 may acquire the information from the database 3 as needed. The device configuration of the order parameter generation support system 1 can be appropriately changed as long as the object of the present embodiment is not impaired.

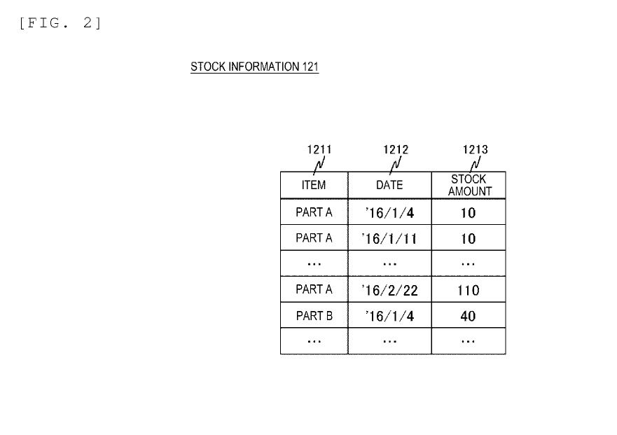

FIG. 2 is a diagram illustrating an example of a data structure of the stock information 121. The stock information 121 includes an item 1211, a date 1212, and a stock amount 1213. The item 1211 is information indicating an item of a part handled by the ordering entity. The date 1212 is information indicating a time that becomes a reference of the stock amount. The date 1212 is set to a past date. The stock amount 1213 is information indicating an actual value of the stock amount at a time specified by the date 1212. In addition, it is preferable that the stock amount 1213 is information acquired at a common timing (for example, at 8 a.m., a predetermined time) among the days specified by the date 1212.

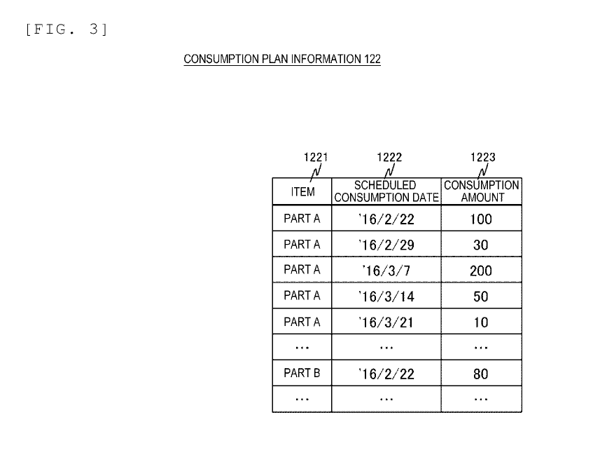

FIG. 3 is a diagram illustrating an example of a data structure of the consumption plan information 122. The consumption plan information 122 includes an item 1221, a scheduled consumption date 1222, and a consumption amount 1223. The item 1221 is information indicating an item of a part handled by the ordering entity. The scheduled consumption date 1222 is information indicating a scheduled consumption time of a part specified by the item 1221. The consumption amount 1223 is a consumption amount in a consumption plan and is information indicating an amount of parts expected to be consumed as the scheduled consumption date 1222. In addition, a history of the consumption plan information 122 is stored in an area (not illustrated) of the storage unit 12.

In other words, the consumption amount 1223 may be an amount of parts expected to be consumed in a predetermined period starting from the scheduled consumption date 1222 (for example, a period ending the day before the other scheduled consumption date 1222). In addition, although the consumption plan date 1222 illustrated in FIG. 3 indicates a date every week, the consumption plan date 1222 is not limited thereto and may be, for example, every day.

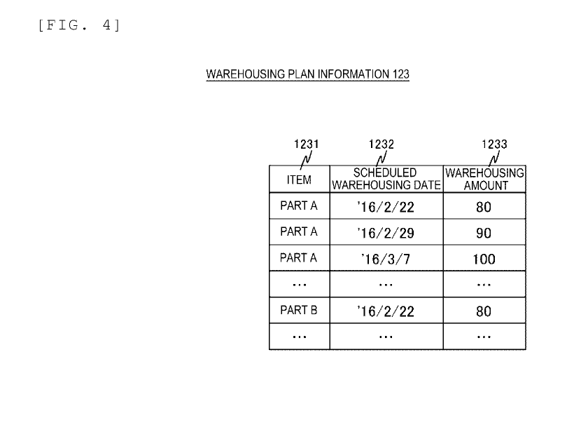

FIG. 4 is a diagram illustrating an example of a data structure of the warehousing plan information 123. The warehousing plan information 123 includes an item 1231, a scheduled warehousing date 1232, and a warehoused amount 1233. The item 1231 is information indicating an item of a part handled by the ordering entity. The scheduled warehousing date 1232 is information indicating a scheduled time at which a part specified by the item 1231 is to be warehoused. The warehoused amount 1233 is information indicating an amount of parts scheduled to be warehoused at the scheduled warehousing date 1232. In addition, similarly to the consumption plan information 122, the warehoused amount 1233 may be an amount of parts to be warehoused in a predetermined period starting from the scheduled warehousing date 1232.

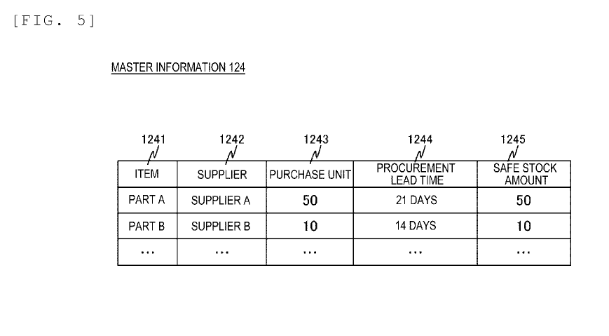

FIG. 5 is a diagram illustrating an example of a data structure of the master information 124. The master information 124 includes an item 1241, a supplier 1242, a purchase unit 1243, a procurement lead time 1244, and a safe stock amount 1245. The item 1241 is information indicating an item of a part handled by the ordering entity. The supplier 1242 is information indicating a supplier which is a supplier of a part. The purchase unit 1243 is information indicating a unit amount at the time of purchasing a part specified by the item 1241 from the supplier 1242.

The procurement lead time 1244 is information indicating a period from ordering of a part to the supplier 1242 to delivery. The safe stock amount 1245 is information indicating an amount of a reserve stock of the ordering entity.

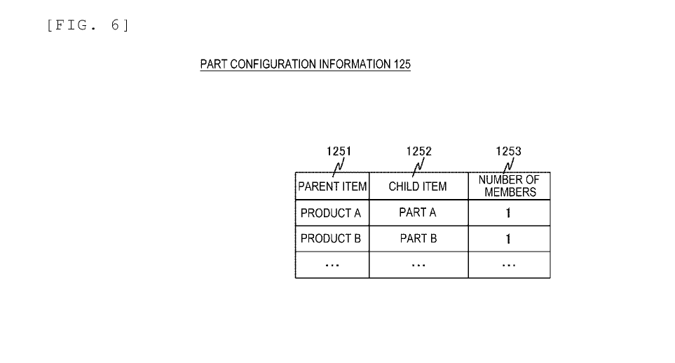

FIG. 6 is a diagram illustrating an example of a data structure of the part configuration information 125. The part configuration information 125 includes a parent item 1251, a child item 1252, and a number of members 1253. The parent item 1251 is information indicating a part or a product constituted by parts. The child item 1252 is information specifying a part constituting a related parent item 1251. The number of members 1253 is information indicating an amount of child items 1252 required for constituting the parent item 1251.

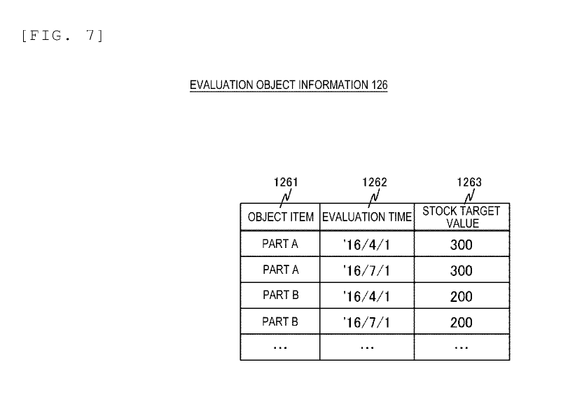

FIG. 7 is a diagram illustrating an example of a data structure of the evaluation object information 126. The evaluation object information 126 includes an object item 1261, an evaluation time 1262, and a stock target value 1263. The object item 1261 is information indicating an item of a part which is an evaluation object. The evaluation time 1262 is information specifying a reference time when evaluation is to be performed. The stock target value 1263 is information indicating a stock amount of a part which is an evaluation reference at the evaluation time 1262.

In the uppermost record of FIG. 7, the object item 1261 is “Part A”, the evaluation time 1262 is “16/4/1”, and the stock target value 1263 is “300”. In this case, when the stock evaluation unit 118 evaluates the combination of order parameters, if the stock amount of “Part A” at “16/4/1” calculated by using the combination of order parameters is 0 or more and 300 or less, it is determined that the combination of order parameters is appropriate.

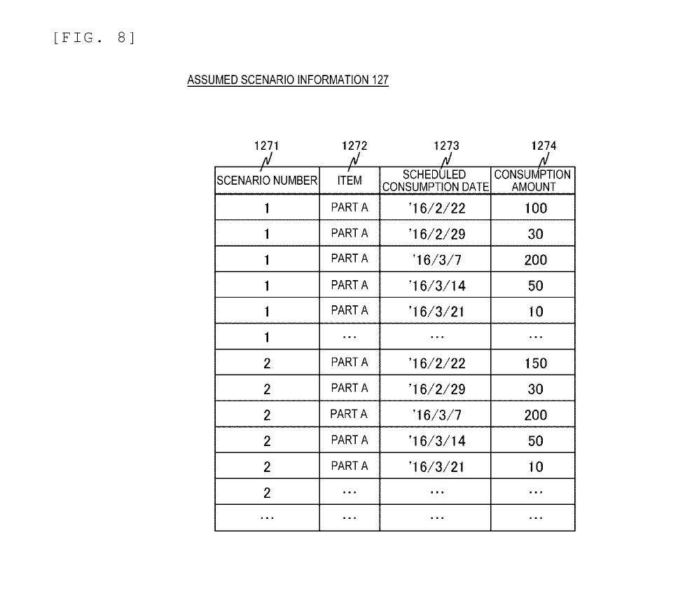

FIG. 8 is a diagram illustrating an example of a data structure of the assumed scenario information 127. The assumed scenario information 127 includes a scenario number 1271, an item 1272, a scheduled consumption date 1273, and a consumption amount 1274. The scenario number 1271 is identification information identifying an assumed consumption amount plan. In one scenario number 1271, one item 1272 and one or a plurality of consumption plan dates 1273 are associated.

The item 1272 is information indicating an item of apart handled by the ordering entity. The consumption plan date 1273 is information indicating the assumed time of consumption of the part. The consumption amount 1274 is information indicating an assumed consumption amount of the part related to the item 1272 in the scheduled consumption date 1273. In addition, similarly to the stock information 121, the consumption amount 1274 may be the amount of parts expected to be consumed during a predetermined period (for example, a period using the previous day of the other scheduled consumption date 1273 as the end time) using the scheduled consumption date 1273 as the start time.

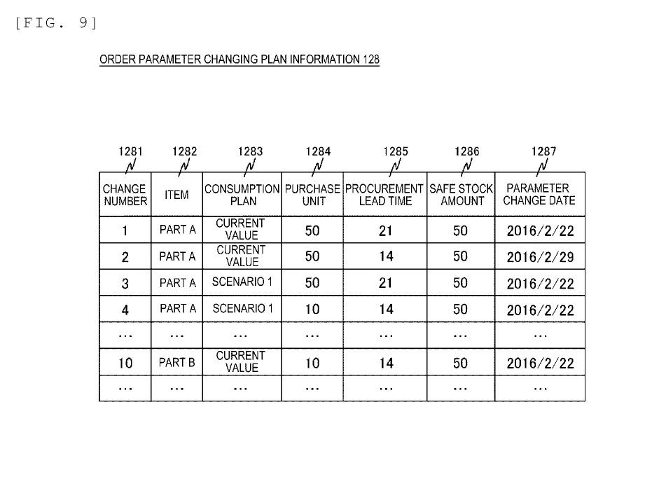

FIG. 9 is a diagram illustrating an example of a data structure of the order parameter changing plan information 128. The order parameter changing plan information 128 includes a change number 1281, an item 1282, a consumption plan 1283, a purchase unit 1284, a procurement lead time 1285, a safe stock amount 1286, and a parameter change date 1287.

The change number 1281 is identification information identifying a combination of an order parameter and a consumption amount. The item 1282 is information indicating an item of a part handled by the ordering entity. The consumption plan 1283 is information specifying a consumption amount used for calculating a stock amount in determining whether or not the combination of order parameters is appropriate. In a case where the consumption plan 1283 is “current value”, the stock amount is calculated by using the consumption amount of the consumption plan information 122. In a case where the consumption plan 1283 is “Scenario 1”, the stock amount is calculated by using the record in which the scenario number 1271 of the assumed scenario information 127 is “1”.

The combination of the purchase unit 1284, the procurement lead time 1285, and the safe stock amount 1286 is handled as a combination of order parameters. The purchase unit 1284 is information indicating a unit amount at the time of purchasing a part from the supplier. The procurement lead time 1285 is information indicating a period required from ordering a part to the supplier to delivery. The safe stock amount 1286 is information indicating an amount of a reserve stock of the ordering entity.

The parameter change date 1287 is information indicating a change time of each order parameter constituting the combination of order parameters. In determining whether or not the combination of order parameters is appropriate, the stock amount in a case where the order parameter is changed on the parameter change date 1287 is calculated.

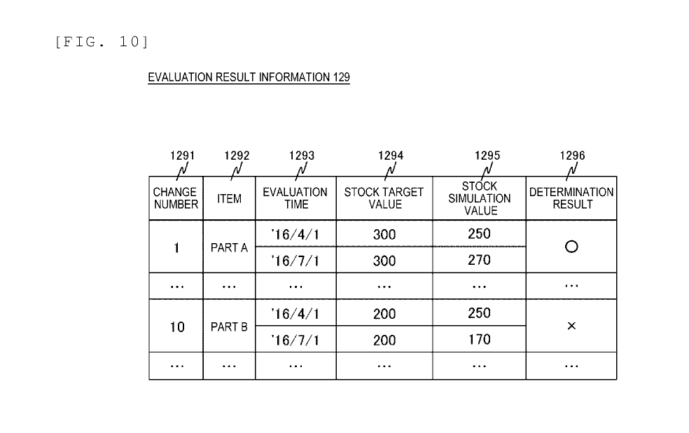

FIG. 10 is a diagram illustrating an example of a data structure of the evaluation result information 129. The evaluation result information 129 includes a change number 1291, an item 1292, an evaluation time 1293, a stock target value 1294, a stock simulation value 1295, and a determination result 1296.

The change number 1291 is identification information identifying a combination of an order parameter and a consumption amount that has been evaluated and corresponds to the change number 1281 of the order parameter changing plan information 128. The item 1292 is information indicating an item of a part for which evaluation is performed. The evaluation time 1293 is information specifying a reference time when evaluation is to be performed and corresponds to the evaluation time 1262 of the evaluation object information 126. The stock target value 1294 is information indicating a stock amount of a part which is an evaluation reference at the evaluation time 1293 and corresponds to the stock target value 1263 of the evaluation object information 126.

The stock simulation value 1295 is information indicating a stock amount of a part related to the item 1292 at the evaluation time 1293. The determination result 1296 is information indicating whether or not the combination of order parameters included in the order parameter changing plan information 128 is appropriate. In the present embodiment, in a case where the stock simulation value 1295 satisfies a predetermined condition specified by the evaluation time 1293 and the stock target value 1294, the combination of order parameters is treated as being appropriate.

In addition, in FIG. 10, the determination result 1296 is set for each change number 1291, and in a case where all the stock simulation values 1295 among the evaluation times 1293 associated with one change number 1291 satisfy the condition, the determination result 1296 that the combination of order parameters is appropriate is set. However, the method of setting the determination result 1296 is not limited thereto. For example, in a case where at least one stock simulation value 1295 among the evaluation times 1293 associated with one change number 1291 satisfies the condition, the determination result 1296 that the combination of order parameters is appropriate may be set.

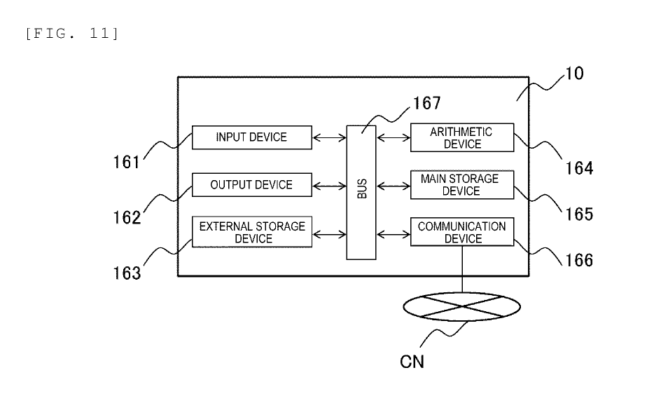

FIG. 11 is a diagram illustrating a hardware configuration example of the order parameter generation supporting device 10. The order parameter generation supporting device 10 is configured to include an input device 161, an output device 162, an external storage device 163, an arithmetic device 164, a main storage device 165, and a communication device 166, and each component is connected via a bus 167.

The input device 161 is a device that receives an input operation from a user, and is, for example, a touch panel, a keyboard, a mouse, a microphone, or the like. The output device 162 is a device that performs an output process for a data stored in the order parameter generation supporting device 10 and is, for example, a display device such as an LCD (Liquid Crystal Display), a printer, or the like.

The external storage device 163 is, for example, a writable, readable storage medium such as an HDD (Hard Disk Drive). The arithmetic device 164 is a central processing unit and executes a process according to a program recorded in the main storage device 165 or the external storage device 163. Each processing unit constituting the control unit 11 implements respective functions by allowing the arithmetic device 164 to execute the program.

The main storage device 165 is a storage device such as a RAM (Random Access Memory) or a flash memory and functions as a storage area for temporarily reading programs and data. The communication device 166 is a device for connecting the order parameter generation supporting device 10 to the network CN and is, for example, a communication device such as an NIC (Network Interface Card).

The function of the storage unit 12 is implemented by the external storage device 163 or the main storage device 165. In addition, the storage unit 12 may implement the function by a storage device on the network CN, or as described above, the function may be implemented by the database 3.

The process of each component of the order parameter generation supporting device 10 may be executed by one piece of hardware or may be executed by a plurality of pieces of hardware. In addition, the process of each component of the order parameter generation supporting device 10 may be implemented by one program or may be implemented by a plurality of programs. Since the user terminal 2 and the database 3 also have the same hardware configuration as the order parameter generation supporting device 10, the description thereof will be omitted.

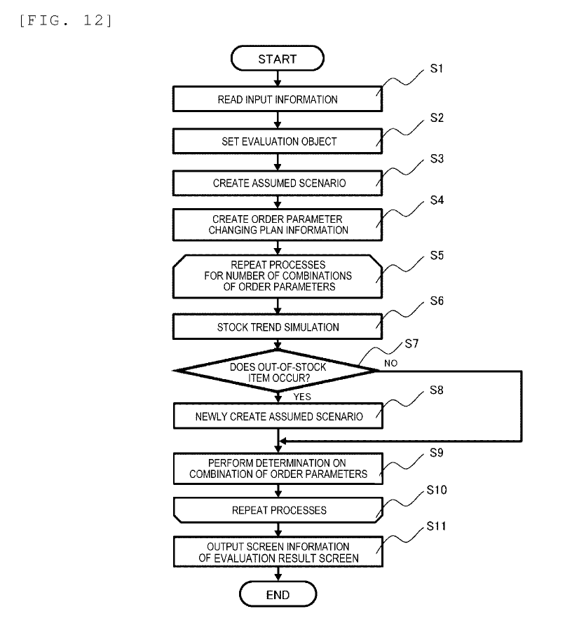

FIG. 12 is a flowchart illustrating an example of an order parameter generation supporting process. This process is started, for example, in a case where the order parameter generation supporting device 10 receives an instruction to start the order parameter generation supporting process output by the user terminal 2. In addition, this process may be performed, for example, periodically in the order parameter generation supporting device 10.

First, the stock information reception unit 111, the plan information reception unit 112, and the master information reception unit 113 read input information (step S1). More specifically, the stock information reception unit 111 reads the stock information 121 at the time of processing, for example, from the database 3 and stores the stock information in the storage unit 12. The plan information reception unit 112 reads the consumption plan information 122 and the warehousing plan information 123 at the time of processing, for example, from the database 3 and stores the consumption plan information and the warehousing plan information in the storage unit 12.

The master information reception unit 113 reads the master information 124 and the part configuration information 125, for example, from the database 3 and stores the master information and the part configuration information in the storage unit 12.

Next, the evaluation object reception unit 114 sets the evaluation object (step S2). More specifically, the evaluation object reception unit 114 receives the evaluation object information 126, for example, from the database 3 and stores the evaluation object information in the storage unit 12. The evaluation object reception unit may create the evaluation object information 126 by prompting the user terminal 2 to input the information specifying the evaluation object.

Next, the assumed scenario creation unit 115 creates the assumed scenario information 127 (step S3). The assumed scenario creation unit 115 creates the assumed scenario information 127 by acquiring a history of the consumption plan information 122 of which the consumption plan date 1222 is earlier than the processing time, for example, from the database 3 and estimating the consumption fluctuation tendency.

Next, the order parameter changing combination creation unit 116 creates the order parameter changing plan information 128 (step S4). More specifically, the order parameter changing combination creation unit 116 creates the screen information of prompting to input the range of the order parameter and transmits the screen information to the user terminal 2, so that the range of the order parameter is acquired.

In the present embodiment, the purchase unit, the procurement lead time, and the safe stock amount are included in the order parameter. For each order parameter, the order parameter changing combination creation unit 116 generates screen information prompting the inputting of the maximum value, the minimum value, the step number (pitch width), the start time, end time, and pitch width (daily, weekly, or the like) of the parameter change date.

In addition, the order parameter changing combination creation unit 116 may prompt the inputting of the range of the order parameter candidate for each part included in the item 1211 in the stock information 121 and may prompt the inputting of the range of the order parameter candidate which is common to each part. Therefore, for each of the parts handled by the ordering entity, the order parameter candidates which are to be change candidates of each order parameter are extracted.

For example, in a case where the maximum value is “21”, the minimum value is “0”, and the number of steps is “7” for the procurement lead time, “0”, “7”, “14”, and “21” are extracted as the order parameter candidates of the procurement lead time. In a case where there is no input of the range for other order parameters, this case is treated as having no change candidate for the order parameters.

With respect to the item 1211 included in the stock information 121, the order parameter changing combination creation unit 116 creates a combination of order parameters by associating the consumption amount included in the consumption plan information 122, the consumption amount included in the assumed scenario information 127, the order parameters included in the master information 124, the extracted order parameter candidate, and one or a plurality of parameter change dates specified by the input in a round-robin manner. The order parameter changing combination creation unit 116 creates the order parameter changing plan information 128 including the combination of order parameters in each record.

In addition, the order parameter changing plan information 128 includes a record in which the consumption amount included in the consumption plan information 122 and the order parameter included in the master information 124 are associated with each other. The record does not include the order parameter candidate. For this reason, the stock amount calculated by using the record is treated as the planned stock amount at the current time.

Next, the control unit 11 repeats the processes from step S5 to step S10 for the number of combinations of order parameters. The number of combinations of order parameters is, for example, the number of records of the order parameter changing plan information 128. In addition, the control unit 11 may previously receive designation of a combination of order parameters for performing the following stock trend simulation.

First, the stock trend simulation unit 117 performs the stock trend simulation (step S6).

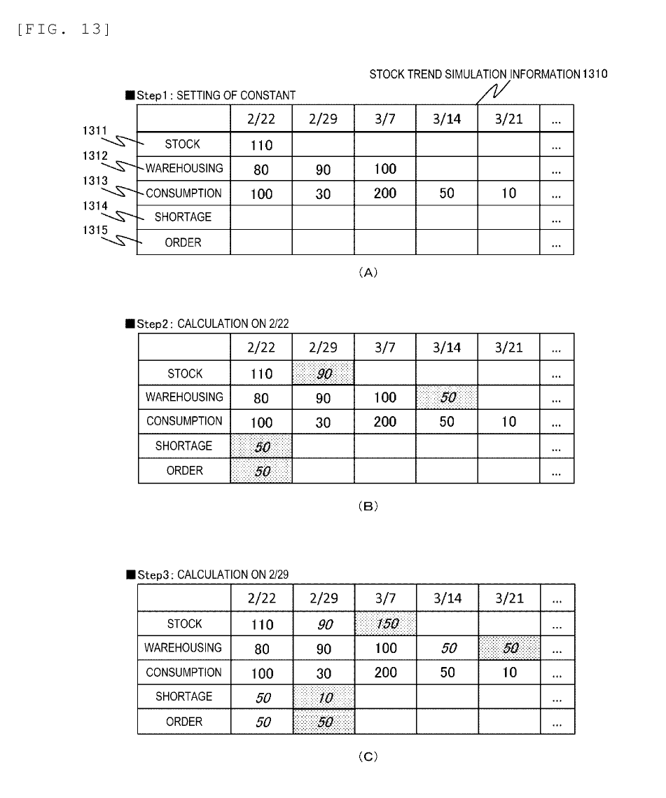

FIG. 13 is a diagram illustrating an example of a stock trend simulation process. This figure illustrates stock trend simulation information 1310 in a case where stock trend simulation is executed for the part A by using the combination of order parameters in which the change number 1281 of the order parameter changing plan information 128 illustrated in FIG. 9 is “1”.

As illustrated in FIG. 13, the stock trend simulation information 1310 has, for example, a table format in which the date is taken in the horizontal direction and each item is taken in the vertical direction. The date in the horizontal direction may be determined according to the business cycle and may be, for example, in a daily cycle or a monthly cycle in addition to the weekly cycle illustrated in FIG. 13.

The item in the vertical direction is described. The stock 1311 represents the stock amount of parts at the start of operation of each date. The warehousing 1312 represents the amount of parts which are to be warehoused from the start of operation of each date until the next date. The consumption 1313 represents the number of parts which are to be used from each date to the next date.

The shortage 1314 represents a required number of procurements (stock shortage number) calculated by subtracting the consumption 1313 from the sum of stock 1311 and the warehousing 1312 of each date. The order 1315 represents the amount of orders to the supplier in consideration of the purchase unit with respect to the value of the shortage 1314.

First, “Step 1: Setting of Constant” illustrated in FIG. 13(A) will be described. The stock 1311 can be specified from the stock information 121. The stock trend simulation unit 117 specifies the stock amount at the time when the date is “2/22” by using the stock information 121 and sets the stock amount in the “2/22” column of the stock 1311. Next, the stock trend simulation unit 117 specifies the warehoused amount at the time of “2/22” of the part A by using the warehousing plan information 123 and sets the warehoused amount in the “2/22” column of the warehousing 1412.

The stock trend simulation unit 117 sets the consumption amount in the consumption plan 1283 included in the consumption plan information 122 or the assumed consumption amount included in the assumed scenario information 127 as the consumption 1313. In the record of which the change number 1281 of the order parameter changing plan information 128 illustrated in FIG. 9 is “1”, since the consumption plan 1283 is “current value”, the stock trend simulation unit 117 sets the consumption amount 1223 included in the consumption plan information 122 as the consumption 1313.

Next, “Step 2: Calculation on 2/22” illustrated in FIG. 13(B) will be described. In the record of which the change number 1281 of the order parameter changing plan information 128 illustrated in FIG. 9 is “1”, as the combination of order parameters, the purchase unit 1284 is set to “50”, the procurement lead time 1285 is set to “21”, and the safe stock amount 1286 is set to “50”. In addition, since each of the order parameters is the same as the order parameter of “Part A” in the master information 124 illustrated in FIG. 5, it can be understood that stock trend simulation is performed in a case where the order parameters are not changed.

Since the procurement lead time is “21” (three weeks), the stock trend simulation unit 117 needs to order the required amount for three weeks from the time of “2/22” up to the time of “3/14”. The required number is “430” which is the sum of “380” (100+30+200+50) from the consumption 1313 and “50” which is the safe stock amount. Since “110” in the stock 1311 and “80”, “90”, and “100” in the warehousing 1312 have been prepared, the total number “380” is the prepared amount.

The stock trend simulation unit 117 calculates the shortage number by subtracting the prepared number from the required number. In this example, “50” (430−380) is the shortage number. The stock trend simulation unit 117 sets “50” to the shortage 1314. The order 1315 is determined by rounding up the shortage 1314 so that the order becomes a multiple of the purchase unit which is one of the order parameters. In this example, since the purchase unit is “50”, “50” is set in the order 1315. In addition, since this order is warehoused on 3/14, “50” is set in the “3/14” column of the warehousing 1312.

In addition, by subtracting the consumption 1313 from the sum of the stock 1311 and the warehousing 1312, the stock amount of the next date can be known. In this example, the stock amount on “2/29” is “90” (110+80−100). The stock trend simulation unit 117 sets “90” in the stock 1311 on the date “2/29”.

Next, “Step 3: Calculation on 2/29” illustrated in FIG. 13(C) will be described. Similarly to Step 2, the required number can be calculated to be “340” which is the sum of the consumption 1313 and the safe stock amount (30+200+50+10+50 (safe stock amount)). In addition, the prepared number can be calculated as “330” which is the sum of the stock amount and the warehoused amount (90 (stock amount at the time of 2/29)+240 (90+100+50 which is the warehoused amount from 2/29 to 3/14)=330). Since the shortage 1314 is “10” (340−330), the order 1315 is rounded up to “50” on the basis of the purchase unit.

Since this order is warehoused on 3/21, “50” is set in the “3/21” field of the stock 1311. In addition, “150” (90+90−30) is set as the stock 1311 on “3/7”. The stock trend simulation unit 117 repeats this process until the date of the stock trend simulation information 1310 becomes the final date included in the consumption plan information 122 or the assumed scenario information 127.

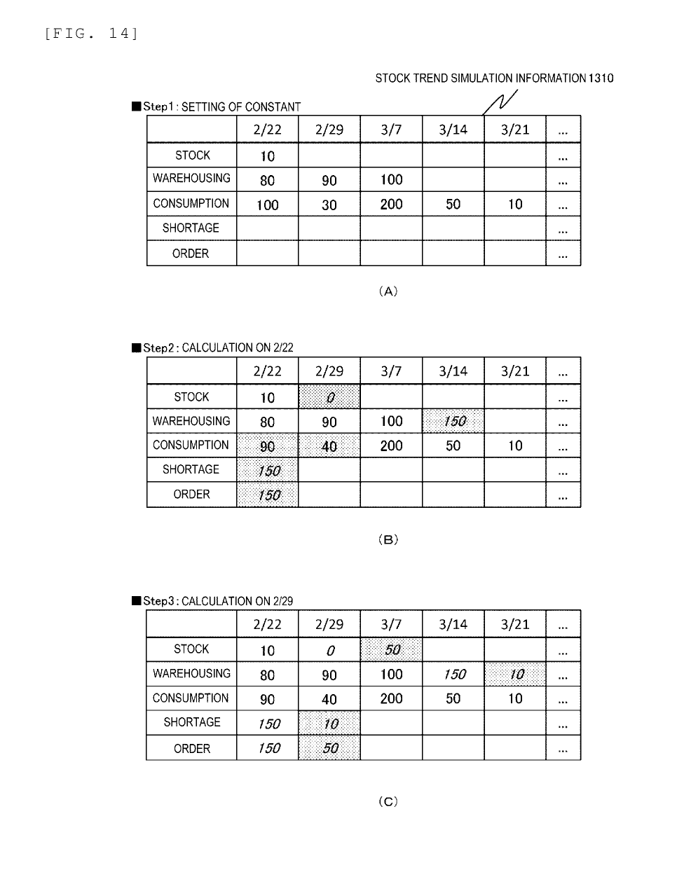

FIG. 14 is a diagram illustrating an example of the stock trend simulation process in a case where an out-of-stock item occurs. The stock trend simulation unit 117 adjusts the consumption amount and performs the stock trend simulation in a case where an out-of-stock item occurs in a part.

In “Step 1: Constant setting” illustrated in FIG. 14(A), the stock 1311 on “2/22” is set to “10”. As a result, in “Step 2: Calculation on 2/22” illustrated in FIG. 14(B), in calculating the stock on “2/29”, the consumption 1313 on “2/22” is “100”, the stock 1311 is “10”, and the warehousing 1312 is “80”, so that “10” out-of-stock items occur. For this reason, the stock trend simulation unit 117 changes the consumption 1313 on “2/22” from “100” to “90” and changes the consumption 1313 on “2/29” from “30” to “40”, so that the stock 1311 on “2/29” is set to “0”.

The description is returned to FIG. 12. Next, the stock trend simulation unit 117 determines whether or not an out-of-stock item occurs (step S7). More specifically, the stock trend simulation unit 117 determines that an out-of-stock item occurs in a case where a date occurs with a consumption amount larger than a value obtained by adding the stock amount and the warehoused amount as described above. In a case where the stock trend simulation unit 117 determines that no shortage occurs (“NO” in step S7), the stock trend simulation unit 117 allows the process to proceed to step S9.

In a case where it is determined that an out-of-stock item occurs (“YES” in step S7), the stock trend simulation unit 117 newly creates an assumed scenario (step S8). More specifically, the stock trend simulation unit 117 creates the stock trend simulation information 1310 of which consumption amount is adjusted as described above. In addition, the stock trend simulation unit 117 generates a new record in the assumed scenario information 127 by using the adjusted consumption amount and the date when the consumption amount is adjusted. A flag (not illustrated) indicating that the consumption amount is adjusted according to the result of the stock trend simulation may be associated with the generated record.

In addition, the stock trend simulation unit 117 may correct the consumption amount 1223 of the consumption plan information 122 to the adjusted consumption amount by using the created stock trend simulation information 1310.

Next, the stock evaluation unit 118 performs a determination on the combination of order parameters (step S9). By referring to the stock trend simulation information 1310 by using the evaluation object information 126, the stock evaluation unit 118 determines whether the stock 1311 at the evaluation time 1262 satisfies the condition in the evaluation object information 126. In other words, with respect to the consumption amount (the consumption amount in the consumption plan or the assumed consumption amount in the assumed scenario information 127) for which the stock trend simulation has been performed, the stock evaluation unit 118 determines whether or not the combination of order parameters related to the order parameter changing plan information 128 is appropriate by using the stock amount obtained as a result of the stock trend simulation.

The stock evaluation unit 118 creates the evaluation result information 129 by using the item of the part for which the stock trend simulation has been performed, the evaluation time at which the determination has been made, the stock target value, and the stock amount at the evaluation time and stores the evaluation result information in association with the determination result 1296 in the storage unit 12.

After the repetitive processes of steps S5 to S10, the order parameter changing plan output unit 119 outputs the screen information of the evaluation result screen (step S11). The order parameter changing plan output unit 119 generates the screen information of the evaluation result screen and transmits the screen information to the user terminal 2. After that, the control unit 11 ends the processes of this flowchart.

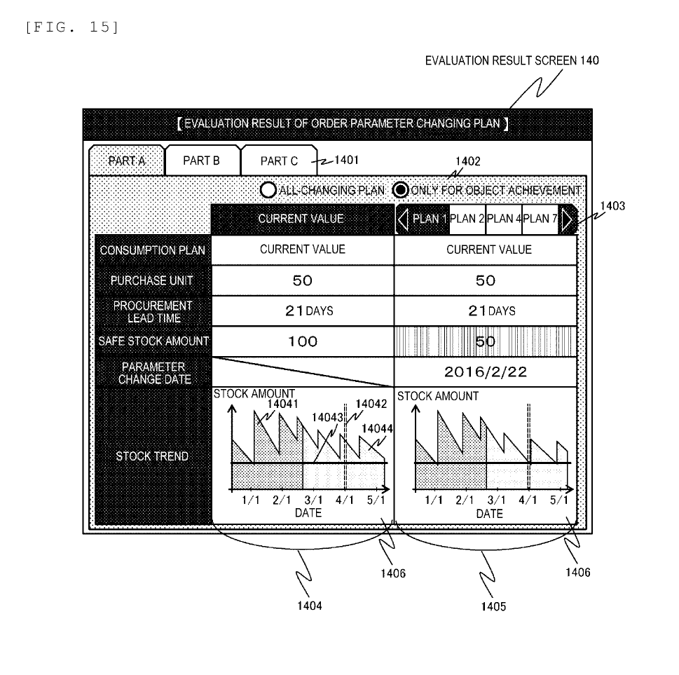

FIG. 15 is a diagram illustrating an example of the evaluation result screen 140. The evaluation result screen 140 includes an item selection tab 1401, a changing plan refinement button 1402, a changing plan selection button 1403, a current parameter display area 1404, and a change candidate parameter display area 1405.

The item selection tab 1401 selectably displays all the items included in the stock information 121. The combination of order parameters related to the selected item is displayed in the current parameter display area 1404 and the change candidate parameter display area 1405.

The changing plan refinement button 1402 is a button for receiving the selection of the display object of the combination of order parameters displayed in the change candidate parameter display area 1405. The changing plan refinement button 1402 receives, for example, selection whether to display all the evaluation result information 129 generated for the part selected by the item selection tab 1401 as display objects or to display the combination of order parameters determined to be appropriate as a display object.

The changing plan selection button 1403 is a button for receiving selection of the combination of order parameters displayed in the change candidate parameter display area 1405 in a case where there are a plurality of combinations of order parameters which is a display object by selection of the changing plan refinement button 1402.

By referring to the evaluation result information 129, the order parameter changing plan output unit 119 specifies the evaluation result information 129 which has the part selected by the item selection tab 1401 in the item 1292 and in which one of the order parameters including the change time 1203, the stock target value 1204, and the stock simulation value 1295 is different from the order parameter included in the master information 124. In addition, the order parameters that are different from the order parameters of the master information 124 are treated as the order parameter candidates. The order parameter changing plan output unit 119 generates the display information that selectably displays the information indicating the record of the evaluation result information 129 including the order parameter candidate as the changing plan selection button 1403.

The current parameter display area 1404 is an area for displaying a combination of order parameters and a stock trend using the combination at the time of performing the order parameter generation supporting process, that is, at the current time. The current parameter display area 1404 is displayed by using the combination of order parameters included in the master information 124. In the current parameter display area 1404, information indicating the “current value” indicating the consumption amount included in the consumption plan information 122 as the consumption plan is displayed.

The current parameter display area 1404 includes a stock trend display area 1406. The stock trend display area 1406 is an area for displaying a graph illustrating the stock trend calculated by using the combination of order parameters. The stock trend display area 1406 includes a past trend 14041, an evaluation time 14042, a stock target value 14043, and a future trend 14044.

The past trend 14041 is a graph illustrating the stock trend before the start of the order parameter generation supporting process. The evaluation time 14042 is a line indicating the evaluation time (reference time) of the process. The stock target value 14043 is a line indicating the stock target value which is an evaluation reference in the process. The future trend 14044 is a graph illustrating the stock trend after the process.

In addition, the order parameter changing plan output unit 119 generates the display information of the stock trend display area 1406 by referring to the created stock trend simulation information 1310 of the stock trend simulation unit 117. It can be said that the stock trend display area 1406 currently included in the current parameter display area 1404 includes the planned stock amount.

Additionally, the graph illustrating the stock trend is not limited to the modes illustrated in FIG. 15. In addition, since the graph displayed in the stock trend display area 1406 of the current parameter display area 1404 is the simulation result performed by using the combination of order parameters in the master information 124 and the consumption amount in the consumption plan, the graph includes the planned stock amount at the time of processing.

The change candidate parameter display area 1405 is an area for displaying the combination of order parameters including the order parameter candidate selected by the changing plan selection button 1403. Among the order parameters constituting the combination of order parameters, the order parameter candidate is displayed in such a manner that the order parameter candidate is distinguished from the other order parameters. In the change candidate parameter display area 1405 illustrated in FIG. 15, the safe stock amount which is an order parameter candidate is displayed with a background color different from those of the other order parameters.

In addition, in a case where the combination of order parameters determined to be appropriate is selected as the display object in the changing plan refinement button 1402, the combination of order parameters determined to be appropriate is displayed in the change candidate parameter display area 1405. In addition, in a case where all items are selected as the display object in the changing plan refinement button 1402, information indicating whether or not the displayed combination of order parameters is appropriate is displayed in the change candidate parameter display area 1405.

The change candidate parameter display area 1405 includes a consumption plan and a parameter change date. The consumption plan indicates whether the consumption amount used in the stock trend simulation is included in the consumption plan information 122 or which of the assumed scenario information 127 the consumption amount is included in. The parameter change date is information indicating the parameter change date in a case where the parameter change date is set in the determination of the combination of order parameters.

The change candidate parameter display area 1405 includes a stock trend display area 1406. The stock trend display area 1406 illustrates stock trend by stock trend simulation performed by using a combination of order parameters including the order parameter candidate. The display items are the same as those in the stock trend display area 1406 included in the current parameter display area 1404.

According to the present embodiment, it is possible to recognize which change parameter is preferably changed, when the parameter is preferably changed, and which value the parameter is preferably changed into in order to achieve stock target value for each item. Therefore, even in a case where a person in charge who is poor in knowledge or experience considers the validity of order parameters, appropriate order parameters can be generated and adopted.

In addition, in the present embodiment, since it is possible to determine the order parameter candidate with respect to the assumed consumption amount in addition to the consumption amount related to the consumption plan, in a case where various cases are assumed, it is possible to determine whether or not the combination of order parameters is appropriate. In addition, by displaying the parameter change date, it is possible to recognize a change deadline for the order parameter with adjustment with the supplier.

In addition, in the present embodiment, the stock trend simulation corresponding to the number of records included in the order parameter changing plan information 128 is performed, and the determination as to whether or not the combination of order parameters is appropriate is performed. However, in a case where it is determined that the combination of order parameters is not appropriate, with respect to the order parameter candidate related to the determination, it is possible to omit the determination related to the combination of the other order parameters which is determined not to be more appropriate.

For example, in a case where a stock amount exceeding the stock target value is simulated with a predetermined safe stock amount as an order parameter candidate, if the safe stock amount is further increased, it is naturally determined that the combination of order parameters is not appropriate. In this case, it is possible to omit the process for the record of the order parameter changing plan information 128 having a safe stock amount exceeding the safe stock amount.

In addition, in a case where an out-of-stock item occurs at the time of the stock trend simulation and the consumption amount is adjusted, information on adjustment may be illustrated in the stock trend display area 1406. In that case, for example, the adjusted consumption amount, the time when it was the consumption amount has become an adjustment object, and the like are displayed.

### Modified Example 1

Next, Modified Example 1 of the order parameter generation support system 1 will be described. In Modified Example 1, in a case where the consumption amount is adjusted as a result of the stock trend simulation, the consumption amount is also adjusted for other parts constituting a common product together with the parts of which consumption amount is adjusted, and it is determined whether or not the order parameters are appropriate. Hereinafter, differences from the above embodiment will be described, and redundant description will be omitted.

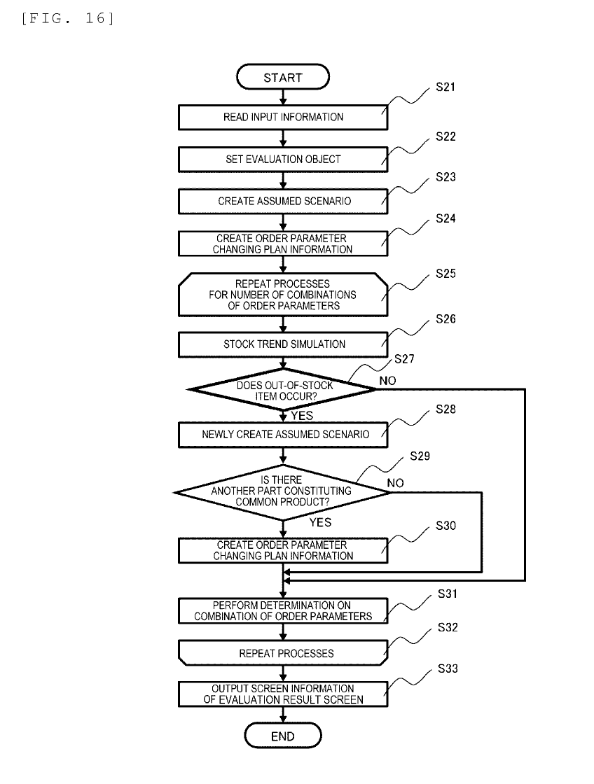

FIG. 16 is a flowchart illustrating an example of an order parameter generation supporting process in Modified Example 1. Since the processes performed in steps S21 to S28 are the same as the processes performed in steps S1 to S8 illustrated in FIG. 12, the description will be omitted.

Next, the order parameter changing combination creation unit 116 determines whether or not there is another part constituting a common product (step S29). More specifically, by referring to the part configuration information 125 by using the item related to the order parameter changing plan information 128 on which the stock trend simulation is currently performed, the order parameter changing combination creation unit 116 identifies the parent item 1251 having the part in the child item 1252. In a case where there is another child item 1252 related to the parent item 1251, the order parameter changing combination creation unit 116 determines that there is another part. In a case where it is determined that there is no another part constituting a common product (“NO” in step S29), the order parameter changing combination creation unit 116 allows the process to proceed to step S31.

In a case where it is determined that there is another part constituting a common product (“YES” in step S29), the order parameter changing combination creation unit 116 creates the order parameter changing plan information 128 (step S30). More specifically, the order parameter changing combination creation unit 116 identifies an assumed consumption amount of the other part by using the consumption amount 1274 of the assumed scenario information 127 newly created in step S28 and the number of members 1253 of the part configuration information 125. The assumed scenario creation unit 115 newly creates a record of the assumed scenario information 127 including the assumed consumption amount for the part.

With respect to the part of the other part, the order parameter changing combination creation unit 116 creates a combination of order parameters for the other part by associating the consumption amount 1274 of the newly created assumed scenario information 127, the order parameter included in the master information 124, the order parameter candidate extracted from the range input in step S24, and one or a plurality of parameter change dates specified by the input in a round-robin manner. The order parameter changing combination creation unit 116 creates the order parameter changing plan information 128 including the combinations of order parameters in each record.

Since the processes performed in steps S31 to S33 are the same as the processes performed in steps S9 to S11 illustrated in FIG. 12, the description will be omitted. In addition, in step S26, the stock trend simulation is also performed on the record of the order parameter changing plan information 128 created in step S30, and it is determined in step S31 whether or not the combination of order parameters is appropriate.

According to this Modified Example, the stock trend simulation is also performed for other parts used for a common product. Therefore, in a case where an item with one out-of-stock part occurs and the consumption amount is adjusted, it is possible to present a changing plan of an appropriate order parameter for other parts that the consumption amount of the part affects, and thus, usability is improved.

### Modified Example 2

Next, Modified Example 2 of the order parameter generation support system 1 will be described. In Modified Example 2, in presenting the combination of order parameters including the order parameter candidate, information on the price required in the case of changing the order parameter is presented. Hereinafter, differences from the above embodiment will be described, and redundant description will be omitted.

Price information (not illustrated) is associated with the master information 124 in Modified Example 2. The price information is, for example, a unit price in the case of adopting the combination of order parameters related to each record of the master information 124. The storage unit 12 stores the history of the master information 124, and the unit price in a case where the order parameter is changed to the order parameter candidate can be statistically calculated. In step S9 illustrated in FIG. 12, the stock evaluation unit 118 calculates the price in the case of using the combination in determining whether or not the combination of order parameters is appropriate. Since the general method is used for the method of calculating the price, the description is omitted.

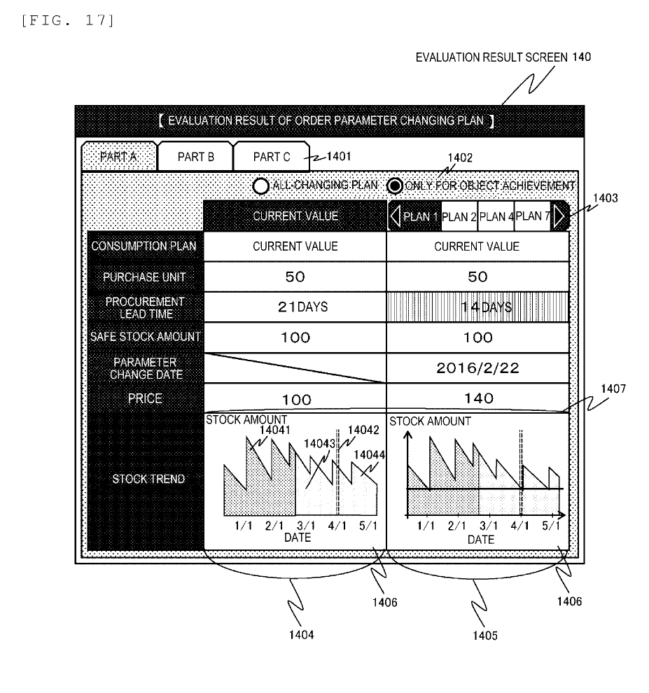

FIG. 17 is a diagram illustrating an example of the evaluation result screen 140 in Modified Example 2. The evaluation result screen 140 includes a price information display area 1407 in each of the current parameter display area 1404 and the change candidate parameter display area 1405. In the price information display area 1407 of the current parameter display area 1404, the price (for example, a unit price) calculated by using the combination of order parameters included in the master information 124 is displayed. In the price information display area 1407 of the change candidate parameter display area 1405, the price calculated by the stock evaluation unit 118 by using the combination of order parameters included in the order parameter changing plan information 128 is displayed.

According to this Modified Example, since it is possible to recognize the cost required for changing the order parameters, it is possible to support the creation of more appropriate order parameters.

While the embodiments and modifications of the present invention have been described above, the present invention is not limited to the examples of the above-described embodiments, but various modifications may be included. For example, the example of the above-described embodiment has been described in detail in order to make the present invention easy to understand, and the present invention is not limited to the example having all the configurations described herein. In addition, a portion of a configuration of one example of an embodiment may be replaced with a configuration of another example. In addition, a configuration of one example of an embodiment may be added with a configuration of another example. In addition, with respect to a portion of the configuration of one example of each embodiment, other configurations may be added, deleted, or replaced. In addition, each of the above-described configurations, functions, processing units, processing means, and the like may be implemented in hardware by designing a portion or all of the configurations, the functions, the processing units, the processing means, and the like, for example, by an integrated circuit. In addition, control lines and information lines in the figures indicate what is considered necessary for explanation, and not all the lines are illustrated. It can be considered that almost all the configurations are connected to each other.

In addition, the functional configuration of the order parameter generation supporting device 10 described above is classified according to main processing contents for easy understanding. The invention of the present application is not limited by the classification method or names of components. As described above, the configuration of the order parameter generation supporting device 10 may be classified into more components according to the processing content. In addition, the configuration may be classified so that one component performs further more processes.

### REFERENCE SIGNS LIST

1: order parameter generation support system
2: user terminal
3: database
10: order parameter generation supporting device
11: control unit
12: storage unit
13: communication unit
14: input unit
15: output unit
111: stock information reception unit
112: plan information reception unit
113: master information reception unit
114: evaluation object reception unit
115: assumed scenario creation unit
116: order parameter changing combination creation unit
117: stock trend simulation unit
118: stock evaluation unit
119: order parameter changing plan output unit
121: stock information
122: consumption plan information
123: warehousing plan information
124: master information
125: part configuration information
126: evaluation object information
127: assumed scenario information
128: order parameter changing plan information
129: evaluation result information
140: evaluation result screen
161: input device
162: output device
163: external storage device
164: arithmetic device
165: main storage device
166: communication device
167: bus
1211 ⋅ 1221 ⋅ 1231 ⋅ 1241 ⋅ 1272 ⋅ 1282 ⋅ 1292: item
1212: date
1213: stock amount
1222, 1273: scheduled consumption date
1223, 1274: consumption amount
1232: scheduled warehousing date
1233: warehoused amount
1242: supplier
1243: purchase unit
1244, 1285: procurement lead time
1245, 1286: safe stock amount
1251: parent item
1252: child item
1253: number of members
1261: object item
1262, 1293: evaluation time
1263, 1294: stock target value
1271: scenario number
1281 ⋅ 1291: change number
1283: consumption plan
1284: purchase unit
1287: parameter change date
1295: stock simulation value
1296: determination result
1310: stock trend simulation information
1311: stock
1312: warehousing
1313: consumption
1314: shortage
1315: order
1401: item selection tab
1402: changing plan refinement button
1403: changing plan selection button
1404: current parameter display area
1405: change candidate parameter display area
1406: stock trend display area
1407: price information display area
CN: network

1. An order parameter generation supporting device, comprising:
a storage unit which stores a consumption amount assumption scenario including an assumed consumption amount, consumption plan information including a consumption amount in a consumption plan, and master information including, as an order parameter which is a value related to an order, the order parameter at a current time;
an order parameter changing combination creation unit which creates a combination of order parameters including an order parameter candidate which is to be a change candidate of the order parameter;
an stock evaluation unit which determines whether or not one or a plurality of combinations of the order parameters is appropriate for each of the consumption amount in the consumption plan and the assumed consumption amount; and
an order parameter changing plan output unit which generates display information of an evaluation result screen including the combination of order parameters on which the determination is performed by the stock evaluation unit.

2. The order parameter generation supporting device according to claim 1, wherein
the order parameter changing combination creation unit receives an input of information specifying a range of a value of the order parameter candidate and creates the combination of order parameters, and
the stock evaluation unit calculates, for each of the combinations of order parameters, a stock amount at a predetermined reference time using the assumed consumption amount and a stock amount at the predetermined reference time using the consumption amount in the consumption plan and determines that the combination of order parameters with respect to the consumption amount in the consumption plan or the assumed consumption amount is appropriate in a case where the stock amount satisfies a predetermined condition.

3. The order parameter generation supporting device according to claim 2, wherein
the order parameter includes at least one of a procurement lead time which is a period from ordering to a supplier to delivery, a purchase unit of a part from the supplier, and a safe stock amount which is an amount of a reserve stock of an ordering entity, and
the stock evaluation unit determines that the combination of order parameters is appropriate in a case where the stock amount at the predetermined reference time is equal to or larger than 0 and equal to or smaller than a predetermined stock target value.

4. The order parameter generation supporting device according to claim 1, wherein
the stock evaluation unit calculates a stock amount using the consumption amount in the consumption plan as the planned stock amount at the current time by using the order parameter at the current time included in the master information, and
the evaluation result screen includes the order parameter at the current time and the planned stock amount at the current time.

5. The order parameter generation supporting device according to claim 1, further comprising
a stock trend simulation unit which generates stock trend simulation information indicating a stock trend of a part by using stock information in which a stock amount is associated with the part, warehousing plan information in which a warehoused amount is associated with the part, and the consumption plan information, wherein
the stock trend simulation unit adjusts the consumption amount of the consumption plan information in a case where a predetermined condition is satisfied, and
the stock evaluation unit determines whether or not the combination of order parameters for the adjusted consumption amount is appropriate with respect to the part for which the stock trend simulation information is generated.

6. The order parameter generation supporting device according to claim 5, further comprising
an assumed scenario creation unit which creates the consumption amount assumption scenario by using the adjusted consumption amount for other parts constituting a product common to the part for which the stock trend simulation information is generated in a case where the consumption amount is adjusted, wherein
the storage unit stores part configuration information indicating the parts constituting the product, and
the stock evaluation unit determines whether or not the combination of order parameters is appropriate for the other parts by using the created consumption amount assumption scenario.

7. The order parameter generation supporting device according to claim 5, wherein
the order parameter changing plan output unit generates the display information of the evaluation result screen in which a graph illustrating the stock trend of the part is associated with each of the combinations of order parameters.

8. The order parameter generation supporting device according to claim 1, wherein
the storage unit stores price information on a price of a part in association with the order parameter,
the stock evaluation unit calculates the price required for each of the combinations of order parameters by using the price information, and
the order parameter changing plan output unit generates the display information of the evaluation result screen in which the price is associated with the combination of order parameters.

9. The order parameter generation supporting device according to claim 1, wherein
the order parameter changing combination creation unit associates information indicating the change time with the combination of order parameters, and
the stock evaluation unit determines whether or not the combination of order parameters in a case where the order parameter at the current time is changed into the order parameter candidate at the change time is appropriate.

10. The order parameter generation supporting device according to claim 1, wherein
the order parameter changing plan output unit receives a selection of whether to display all the combinations for which stock evaluation is performed by the stock evaluation unit or to display the combination of order parameters determined to be appropriate and generates the display information of the evaluation result screen in which information indicating whether or not it is determined that the combination of order parameters is appropriate in a case where the selection of at least displaying all the combinations is received.

11. An order parameter generating method performed by an order parameter generation supporting device, wherein
the order parameter generation supporting device includes a storage unit, an order parameter changing combination creation unit, a stock evaluation unit, and an order parameter changing plan output unit,
the storage unit stores a consumption amount assumption scenario including an assumed consumption amount, consumption plan information including a consumption amount in a consumption plan, and master information including, as an order parameter which is a value related to an order, the order parameter at a current time,
the order parameter changing combination creation unit executes an order parameter change combination creation procedure of creating a combination of order parameters including an order parameter candidate which is to be a change candidate of the order parameter,
the stock evaluation unit executes a stock evaluation procedure of calculating, for each of the combinations of order parameters, a stock amount at a predetermined reference time for each of the assumed consumption amount and the consumption amount in the consumption plan and determining whether or not each of the combination of order parameters is appropriate, and
the order parameter changing plan output unit executes an order parameter changing plan output procedure for displaying an evaluation result screen including the combination of order parameters on which the determination is performed by the stock evaluation unit.
